(19) United States
(12) Patent Application Publication
(10) Pub. No.: US 2007/0086578 A1
(43) Pub. Date: Apr. 19, 2007

(54) Method and apparatus for utilizing 911 and e911 features from a remote location

(75) Inventors: Kim Hansen, Renton, WA (US); James Russell, Seattle, WA (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/573,063

(22) PCT Filed: Sep. 7, 2004
(86) PCT No.: PCT/IB04/51706

§ 371 Date: Mar. 23, 2006

(30) Foreign Application Priority Data
Sep. 30, 2003 (US) 60507094

(51) Int. Cl. H04M 11/04

(52) U.S. Cl. 379/45; 379/33

(57) ABSTRACT

A method and system are disclosed that enable a remote location to first contact a emergency call center due to an emergency/alarm condition and then automatically call 9-1-1 like service and transmit a predetermined message so that local emergency response personal have access to 9-1-1 like features such as automated address and telephone number look-up as well as additional information provided via the message.

The present invention relates to emergency response systems, in particular, to a method and system that enables a remote location to first contact a emergency call center due to an alarm condition and then have an automated call, which includes one or more messages, initiated to a 9-1-1 type service. This enables local emergency response personal to have access to 9-1-1 like features such as automated address and telephone number look-up and also allows the call center and/or the local emergency response personal to have additional information provided via the messages.

Conventional alarm/emergency monitoring systems are designed for personal protection of a predetermined subscriber base and/or protection of property within an area of protection. An emergency call to a call center, e.g., triggered by a home alarm system, can be followed by the transmission by telephone of an emergency report to local emergency response person al so that concerted rescue action can be initiated. The monitoring system is set up so that appropriate police/fire departments and medical personal can be called upon in the event of an emergency. This means, for example, that the monitoring center knows all the local emergency contact numbers (e.g., police, fire, ambulance) and is able to communicate critical information such as the victim's address to the appropriate local emergency response personal.

During an emergency, time is of the essence. The a ability to summon help in a fast, efficient, and error free manner can mean the difference between life and death. It would be a benefit, therefore, if the call center personal did not have to look -up and call the local emergency response personal but could use an automated system like 9-1-1 services. However, the call center cannot simply dial 9-1-1 because that would only contact the emergency response personal servicing the geographic area of the call center and not the emergency response personal in the geographic area of the alarm condition. It is also noted that home medical/alarm systems can generally not be programmed to automatically call 9-1-1 when an alarm condition is detected. This is because many jurisdictions prohibit direct automatic dialing by such systems without screening/participation by a call center.

More specifically, basic 9-1-1 systems generally include a telephone, a telephone company central office and a Public Safety Answering Point (PSAP). Depending on the area of service, typically a county or state, there may be one or more PSAPs. It is the function of PSAP to transfer the call to the proper law enforcement, fire protection, emergency medical service or agency, etc. (collectively, “emergency service providers”) responsible f or responding to the local emergency. All 9-1-1 calls originating from a particular telephone are directed to a particular PSAP through the central office, depending on the exchange of the calling party number (CPN).

Thus, when a telephone call is placed to 9-1-1, the call is automatically routed to a particular PSAP supporting the caller's geographic area. Depending on the nature of the call, certain security, safety and emergency resources may be dispatched in response to the telephone call. For example, if the caller is reporting a crime, a police car may be dispatched to the scene; if the caller is reporting an accident, an emergency rescue vehicle as well as an ambulance may be dispatched.

Generally, the caller will provide the 9-1-1 operator location information so that if any resources are to be dispatched, the resources are directed to the correct location. However, there are situations where the caller does not or cannot provide such location information. For example, the caller may terminate t he call before giving location information; the caller does not know the address of the location; or the caller is not able to communicate the location information for one reason or another. Additionally, if the PSAP is able to identify the location from which a 9-1-1 call has been placed, the legitimacy of the call can be verified (i.e. it can be verified that the caller is, in fact, located where the caller claims he or she is located).

In the United States, basic 9-1-1 service merely provides that 9-1-1 calls are routed to the PSAP serving the subscribing community. In contrast, enhanced 9-1-1 service identifies the telephone number that initiated the emergency call as well as provides the 9-1-1 operator with location information relating to the telephone number. In this regard, as an enhanced 9-1-1 system takes an incoming emergency call, Automatic Number Identification (ANI) information used for establishing long distance calls is delivered to the PSAP. A database inquiry is then dispatched to an Automatic Location Identification (ALI) system that receives the ANI and provides name, address, type of service (business, residential, etc.) and any other information associated with the ANI that is stored in the system.

In addition, many PSAPs that are sup ported by enhanced 9-1-1 systems have automated Geographic Information Systems (GIS) that display the call source's location on a map display. GIS is particularly useful in rural areas were there may be no formal street addresses. This type of GIS display, however, is not possible if the caller's location is ascertained manually (by conversation with the caller) and may or may not be supported by transmission of ALI from a third party call center.

As discussed above, if a conventional call center were to dial 9-1-1 when an emergency/alarm call was received at the call center, a PSAP associated with the exchange of the CPN of the call center would be contacted—not a PSAP associated with the emergency/alarm call that was placed to the call center. This is a significant disadvantage because the enhanced 9-1-1 system facilitates quick response to emergency situations by appropriate local emergency service providers.

The present invention is directed to a method and system that enables a person at a remote location to first contact a emergency call center due to an alarm condition and then have an automated call initiated, which may include one or more messages, to 9-1-1 services so that a PSAP dispatcher has access to the 9-1-1 features such as automated ad dress and telephone number look-up.

The messages may be selected based upon predetermined conditions, alarm indication types and/or the type of communication equipment available, e.g., web cams. For example, if the call center receives a medical alarm condition and voice communication cannot be established with the alarm location, a message may be triggered indicating that the victim may be unconscious or may have had a heart attack.

One embodiment of the present invention is directed to a method for utilizing a telecommunication emergency service by a remote unit. The method includes the steps of detecting at least one alarm condition, contacting a call center upon detection of the at least one alarm condition, upon receiving a command from the call center, automatically contacting the telecommunication emergency service, originating the contact from the location of the alarm condition rather than the call center and transmitting a stored message to the call center and/or the telecommunication emergency service. The telecommunication emergency service may be a 9-1-1 or enhanced 9-1-1 type of service. The resulting communication may include a three-way “conference” call between the location of the alarm, the personnel at the call center, and the telecommunication emergency service.

Another embodiment of the present invention is directed to a device including a controller, a communication interface coupled to the controller, a storage unit including at least one message and an alarm interface coupled t o the controller. The controller is arranged to contact a monitoring center via the communication interface upon detection of an alarm condition from the alarm interface, to contact an local emergency center upon receiving a command from the monitoring center and to transmit the stored message. The communication interface may be a telephone network interface. The local emergency center may be a public safety answering point.

Various aspects of the present invention has significant advantages in that an alarm monitoring call center does not need track all of the potential emergency dispatch numbers across the country and the PSAP dispatcher can take advantage of the features of enhanced 911 such as automatic address lookup. Additionally, since the contact can be made with the call center personnel on the line, the commonplace prohibition of machine generated calls to PSAPs is not violated.

A more complete understanding of the method and apparatus of the present invention is available by reference to the following detailed description when taken in conjunction with the accompanying drawings wherein:

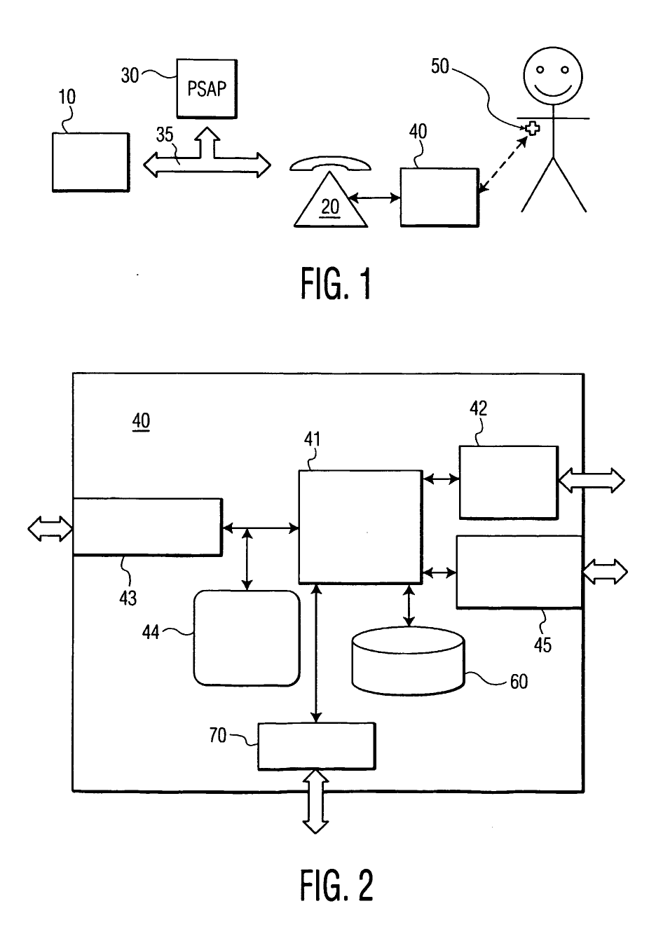

FIG. 1 depicts a diagram of a monitoring system according to an embodiment of the present invention;

FIG. 2 depicts a block diagram of a remote unit according to an embodiment of the present invention; and

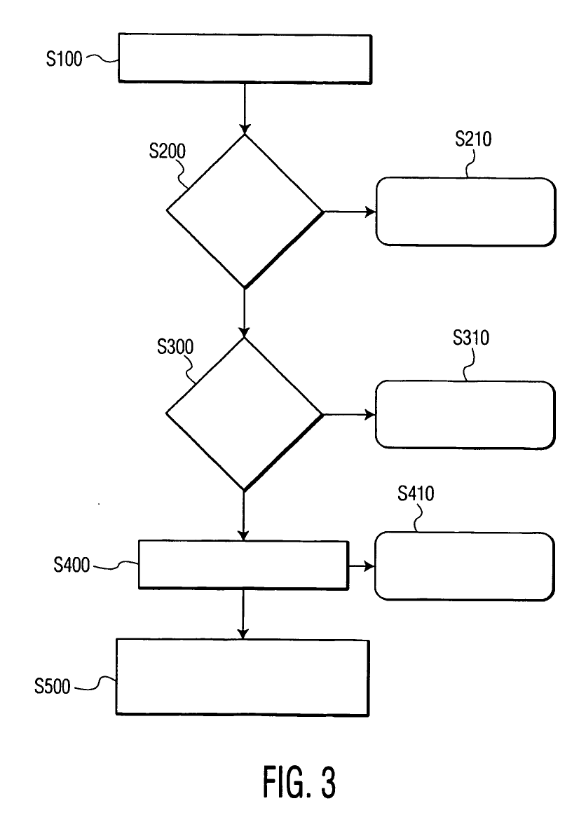

FIG. 3 is a flow chart illustrating the steps of activating 9-1-1 from a remote location in accordance with one aspect of the present invention.

In the following description, for purposes of explanation rather than limitation, specific details are set forth such as the particular architecture, interfaces, techniques, etc., in order to provide a thorough understanding of the present invention. For purposes of simplicity and clarity, detailed descriptions of well-known devices, circuits, and methods are omitted so as not to obscure the description of the present invention with unnecessary detail.

Referring to FIG. 1, a call center 10 is communicatively coupled to a communication interface 20 and a PSAP 30 via a network 35. The call center 10 may represent an alarm-monitoring center, a medical alert center or any similar call/alarm monitoring center. The communication interface 20 may represent a telephone, a personal computer, a cellular phone, a personal digital assistant (PDA), a home alarm system, or any other device capable of communicating over the network 35. The network 35 may represent a global computer communications network such as the Internet, a wide area network, a metropolitan area network, a local area network, a cable network, a satellite network or a telephone network, as well as portions or combinations of these and other types of networks, that are capable of transmitting and/or orientating CPN/ANI/ALI -type information.

In the exemplary system shown in FIG. 1, a remote unit 40 is used to monitor alarm conditions from a patient monitor 50. It should be understood that the embodiments of the present invention are not limited to the exemplary system shown in FIG. 1. Any type of alarm/emergency conditions can be associated with the remote unit 40.

In one embodiment, the communication interface 20 and the remote unit 40 are implemented using a telephone unit capable of automatically contacting (step S200 in FIG. 3) the call center 10 upon detection of an alarm condition (step S100 in FIG. 3) from the patient monitor 50. In the event that communication with the call center 10 cannot be established (step S210 in FIG. 3), after a predetermined number of tries or after a predetermined amount of time has elapsed, the remote unit 40 may automatically contact one or more secondary predetermined emergency response numbers (e.g., call 911).

Once contacted, the call center 10 can then verify (step S300 in FIG. 3) that an alarm condition exists and determine whether emergency personal (e.g., an ambulance) should be sent. For example, in a preferred embodiment, a speakerphone connection is established between a user and the call center 10. The user can verbally verify that an alarm condition exists or the call center may conclude that an alarm condition exists through silence by the user (e.g., the user may be unconscious). It should be understood that it is not necessary for the remote unit 40/communication interface 20 to be a speakerphone.

Referring again to FIG. 2, the remote unit 40 also includes one or more messages 60. The one or more messages 60 may be stored in a storage medium such as an audiotape, Compact Disk (CD), Digital Audio Tape (DAT), semiconductor memory or the like. It is noted that the term “messages” used herein is meant to cover any type of playable audio message including, for example, synthesized audio messages.

The term “messages” is also used to mean any type of non -audio message that may be sent from the remote unit 40 to the call center 10 or the PSAP 30. In one embodiment, the message may include an IP address for a homeowner's web cam so that the call center 10 or the PSAP 30 can have visual access during an alarm condition. Such messages can be transmitted via the network 35 using DTMF signaling or any other digital or analog transmission protocol. In another embodiment, the message may include coded information from the patient monitor 50 and/or from the remote unit 40 such as cached alarm/status state information.

The non-audio messages may be automatically sent by the remote unit 40 in accordance with predefined conditions or may be requested by the call center 10 and/or the PSAP 30 using a command similar to the 9-1-1 command discussed below.

A general message 60 may be transmitted for every call made by the remote unit 40 or particular messages 60 may be trigged based upon different events. For example, different types of alarm conditions (e.g., high blood pressure indication, heart attack, smoke alarm, breaking a window, stepping on a pressure pad) may be associated with different messages 60, e.g.:
“A FIRE ALARM SIGNAL HAS BEEN DETECTED AT 123 MAIN ST.”

In addition, the one or more messages 60 may be automatically triggered and/or based upon action or inaction of a user at a remote location. In this case, if the call center is contacted due to an alarm condition and no voice communication can be established with the alarm location, the following message 60 may be transmitted to a PSAP dispatcher:
“A MEDICAL ALARM HAS BEEN DETECTED AT 123 MAIN ST. THE VICTUM MAY BE UNCONCISOUS.”

In another embodiment, the patient monitor 50 or the remote unit 40 may include a motion sensor, a proximity sensor, a temperature sensor and/or other sensor to detect whet her the patient is conscious and/or near the remote unit 40.

In yet another embodiment, the remote unit 40 may include a recorder 70 (shown in FIG. 2) to capture a voice message from a patient. The recorder 70 may be trigger to capture sounds starting when the alarm condition is first detected by the remote unit 40. In the case of a medical alarm condition, the patient may be conscious for a few moments after a medical alarm condition is triggered. The captured message may be transmitted to the call center 10 and/or to the PSAP 30.

Once the call center 10 concludes that local emergency personal should be contacted, a 9-1-1 command is issued to the remote unit 40 (step S400 in FIG. 3). Remote commands sent from the call center 10 to the remote unit 40 m ay be implemented by having an operator at the call center 10 dial a sequence of one or more DTMF tones, which, when decoded by the remote unit 40 as a match for the 9-1-1 command. Dual-tone multiple frequency (DTMF) signaling is also used in applications requiring interactive control such as in voice mail, phone messaging, e-mail, telephone dialing, voice mail, and telephonic banking systems. In addition to signaling, tone detection is also used in line probing techniques to estimate the quality of phone lines. A DTMF signal consists of a sum of two tones with frequencies taken from two mutually exclusive groups of pre-assigned frequencies. The DTMF tones may be activated from a touchtone telephone interface.

In another embodiment, the remote unit 40 m ay include a voice recognition unit that is trained to recognize spoken commands (“call 9-1-1”) from the call center 10 operator. In yet another embodiment, the remote unit 40 may monitor on -hook, off-hook flashes initiated by the call center 10 operator. For example, three flashes by the call center operator can be recognized by the remote unit 40 as the 9-1-1 command.

Referring now to FIG. 2, a block diagram of the remote unit 40 is shown. The remote unit includes a controller 41, one or more alarm interface units 42, a communication interface 43, a remote command interface 44 and may include one or more messages 60. The one or more alarm interface units 42 may include wireless interfaces and/or hard-wired interface to the patient monitor 50 and/or to other medical and/or alarm sensors. The remote command interface unit 44 may include a DTMF detector, a voice recognition unit and/or a flash detector. The communication unit 43 is capable of communicating to the communication interface 20. It is noted, however, that the communication interface 20 may be integrated with the remote unit 40. The user/audio interface 45 may include a speakerphone unit, a videophone unit or any similar user interface to allow the user to communication with the call center 10.

In other embodiments, the remote unit 40 may be implemented by computer readable code executed by a data processing apparatus. The code may be stored in a memory within the data processing apparatus or read/downloaded from a memory medium such as a CD-ROM or floppy disk. In other embodiments, hardware circuitry may be used in place of, or in combination with, software instructions to implement the remote unit 40.

Upon detection of the 9-1-1 command, the remote unit 40 dials 9-1-1 so that local emergency personal will respond. The emergency response systems that have implemented enhanced 911 would then receive all the relevant enhanced information in the normal fashion. This has several advantages: the call center 10 need not track all of the potential emergency dispatch numbers across the country, the PSAP dispatcher can take advantage of the features of enhanced 911 such as automatic address lookup,

In another embodiment, the remote unit 40 may take advantage of 3-way or conference-calling features made available by many telephone carriers. In this embodiment, after the call center 10 has received a call from the remote unit 40 and determined that assistance is necessary, the call center 10 would command the remote unit 40 to initiate a 3-way conference call with 9-1-1 or other local emergency services (step S410 in FIG. 3). The remote unit 40 would “flash” or momentarily hang up the line with the call center 10, dial 9-1-1 (or other predetermined number), and then flash the line again to connect all three parties together.

This is advantageous because it allows a 3-way connection between PSAP dispatch, the call center 10 and the user (who may be unconscious). Preferably, the remote unit 40/communication interface 20 should support “speakerphone” features so that a 3-way conversation can occur without the user needing to have a handset.

This 3-way connection feature may be necessary in some jurisdictions to accommodate the restriction against automated 9-1-1 calls made directly by alarm/monitoring systems. However, this restriction may also be addressed in some jurisdictions using the one or more messages 60. For example, the call center validation requirement may be address by the remote unit 40 transmitting the following message 60:
“CALL CENTER xyz HAS RECEIVED AN ALARM INDICATION FROM 123 MAIN ST. SEVERAL ATTEMPTS HAVE BEEN MADE TO CONTACT THE HOME OWNER TO NO AVAIL. EMERGENCY RESPONSE PERSONNEL ARE REQUESTED TO INVESTIGATE THE ALARM AT 123 MAIN ST. FOR VERIFICATION, CALL CENTER xyz CAN BE REACHED AT 555 555-555. ”

In other jurisdictions, it may be necessary for the call center 10 to first contact the local emergency response personnel and then send the 9-1-1 command to the remote unit 40. In this case, the following message 60 may be transmitted by the remote unit 40:
“CALL CENTER xyz HAS RECEIVED AN ALARM INDICATION FROM 123 MAIN ST. SEVERAL ATTEMPTS HAVE BEEN MADE TO CONTACT THE HOME OWNER TO NO AVAIL. CALL CENTER xyz HAS ALREADY CONTACTED EMERGENCY RESPONSE PERSONNEL TO INVESTIGATE THE ALARM AT 123 MAIN ST. THIS IS AN AUTOMATED 9-1-1 CALL TO ASSIST THE EMERGENCY RESPONSE PERSONNEL USING E9-1-1 SERVICES. FOR VERIFICATION, CALL CENTER xyz CAN BE REACHED AT 555 555-555.”

It should be understood that the above messages 60 are merely exemplary and may be modified to address different situations. The messages 60 may also be transmitted in more than one language.

In any event, the call center 10 can contact the local emergency response personal directly at anytime before, during or after sending the 9-1-1 command to verify that a response unit has been (or will be) sent to the proper address (step S500 in FIG. 3).

In yet another embodiment, a remote command from the call center 10 to the remote unit 40 may be used to trigger a particular message 60 to be transmitted when automated calls by the remote unit 40 are made.

While the preferred embodiments of the present invention have been illustrated and described, it will be understood by those skilled in the art that various changes and modifications may be made and equivalents may be substituted for elements thereof without departing from the true scope of the present invention. In addition, many modifications may be made to adapt to a particular situation and the teaching of the present invention without departing from the central scope. Therefore, it is intended that the present invention not be limited to the particular embodiment disclosed as the best mode contemplated for carrying out the present invention, but that the present invention include all embodiments falling within the scope of the appended claims.

What is claimed is:

1. A device comprising:
a controller;
a communication interface coupled to the controller;
an alarm interface coupled to the controller; and
a storage unit including at least one message,
wherein the controller is arranged to contact a monitoring center via the communication interface upon detection of an alarm condition from the alarm interface, to contact a local emergency center upon receiving a command from the monitoring center and transmit the at least one message.

2. The device according to claim 1 wherein the communication interface is a telephone network interface.

3. The device according to claim 2 wherein the local emergency center is a public safety answering point.

4. The device according to claim 2 further comprising a dual-tone multiple frequency detector for decoding the command.

5. The device according to claim 1 further comprising a speech recognition unit for determining that the command has been spoken by an operator at the monitoring center.

6. The device according to claim 1 further comprising a flash detector for determining that the command has been received.

7. The device according to claim 1 wherein the at least one message includes an audio message.

8. The device according to claim 1 wherein the at least one message includes non-audio data.

9. The device according to claim 1 further comprising a speakerphone unit.

10. The device according to claim 3, wherein the controller is further arranged to establish a 3-way communication connection among the device, the monitoring center and the public safety answering point.

11. The device according to claim 1, wherein the alarm interface includes a wireless interface.

12. The device according to claim 1, wherein the controller is further arranged to contact at least one additional center if contact with the monitoring center cannot be established.

13. The device according to claim 1, further comprising an audio recorder.

14. A method for utilizing a telecommunication emergency service by a remote unit, the method comprising the steps of:
detecting at least one alarm condition;
automatically contacting a call center upon detection of the at least one alarm condition;
upon receiving a command from the call center, automatically contacting the telecommunication emergency service; and
transmitting a stored message.

15. The method according to claim 14, wherein the telecommunication emergency service is a9-1-1 type of service.

16. The method according to claim 14, wherein the call center monitors a plurality of remote units.

17. The method according to claim 16, wherein the plurality of remote units are associated with at least two different public safety answering points

18. The method according to claim 16, further comprising the step of establishing a 3-way communication connection among the call center, the public safety answering point and the remote unit.

19. The method according to claim 14, further comprising the step of allowing a user within speaking range of the remote unit to communicate with the call center with a hands-free interface.

20. The method according to claim 14, further comprising the step of sending a selection command to the remote unit to select a particular message to be transmitted.
